(19) United States
(12) Patent Application Publication
(10) Pub. No.: US 2022/0113595 A1
(43) Pub. Date: Apr. 14, 2022

(54) DISPLAY DEVICE

(71) Applicant: Japan Display Inc., Tokyo (JP)

(72) Inventors: Shinichi KOMURA, Tokyo (JP); Koichi OKUDA, Tokyo (JP); Ken ONODA, Tokyo (JP); Hiroaki KIJIMA, Tokyo (JP)

(73) Assignee: Japan Display Inc., Tokyo (JP)

(21) Appl. No.: 17/450,477

(22) Filed: Oct. 11, 2021

(30) Foreign Application Priority Data
Oct. 12, 2020 (JP) 2020-171843

(51) Int. Cl. G02F 1/13363; G02F 1/1335

(52) U.S. Cl. CPC G02F 1/133638; G02F 1/133536; G02B 30/34; G02F 2413/04; G02F 1/133526

(57) ABSTRACT

According to one embodiment, a display device including a display panel emitting display light of linearly polarized light, a semi-transparent layer, a first retardation film, a reflective polarizer transmitting first linearly polarized light and reflecting second linearly polarized light orthogonal to the first linearly polarized light, a second retardation film, an element, and a third retardation film arranged between the reflective polarizer and the element, wherein the first retardation film, the second retardation film, and the third retardation film are quarter-wave plates, and the element has a lens action of condensing first circularly polarized light.

### CROSS-REFERENCE TO RELATED APPLICATIONS

This application is based upon and claims the benefit of priority from Japanese Patent Application No. 2020-171843, filed Oct. 12, 2020, the entire contents of which are incorporated herein by reference.

### FIELD

Embodiments described herein relate generally to a display device.

### BACKGROUND

In recent years, a technique of providing, for example, virtual reality (VR) using a head-mounted display mounted on a user's head has been focused. The head-mounted display is configured such that an image is displayed on a display provided in front of user's eyes. The user wearing the head-mounted display can experience virtual reality space with a sense of reality.

Demand for thinning and reduction in weight in such a head-mounted display has been increased.

### BRIEF DESCRIPTION OF THE DRAWINGS

FIG. 1 is a perspective view showing an example of an appearance of a head-mounted display 1 to which a display device of the embodiments is applied.

FIG. 2 is a diagram illustrating a summary of a configuration of the head-mounted display 1 shown in FIG. 1.

FIG. 3 is a cross-sectional view showing a first configuration example of the display device DSP.

FIG. 4 is a cross-sectional view showing an example of a liquid crystal element 10 shown in FIG. 3.

FIG. 5 is a plan view showing an example of an alignment pattern in a liquid crystal layer LC1 shown in FIG. 4.

FIG. 6 is a view illustrating an optical action of the display device DSP.

FIG. 7 is a plan view showing a configuration example of an illumination device 3 applicable to the display device DSP shown in FIG. 3.

FIG. 8 is a cross-sectional view showing a first configuration example of the head-mounted display 1.

FIG. 9 is a cross-sectional view showing a second configuration example of the display device DSP.

FIG. 10 is a cross-sectional view showing an example of an optical element 20 shown in FIG. 9.

FIG. 11 is a view illustrating an optical action of the display device DSP.

FIG. 12 is a cross-sectional view showing a second configuration example of the head-mounted display 1.

FIG. 13 is a view illustrating a first optical element 20B, a second optical element 20G, and a third optical element 20R shown in FIG. 12.

FIG. 14 is a cross-sectional view showing a third configuration example of the display device DSP.

FIG. 15 is a view illustrating first optical elements 201B and 202B, second optical elements 201G and 202G, and third optical elements 201R and 202R shown in FIG. 14.

FIG. 16 is a view illustrating an optical action of the display device DSP.

FIG. 17 is a cross-sectional view showing a fourth configuration example of the display device DSP.

FIG. 18 is a view illustrating an optical action of the display device DSP.

### DETAILED DESCRIPTION

In general, according to one embodiment, a display device includes: a display panel emitting display light of linearly polarized light; a semi-transparent layer; a first retardation film arranged between the display panel and the semi-transparent layer; a reflective polarizer transmitting first linearly polarized light and reflecting second linearly polarized light orthogonal to the first linearly polarized light; a second retardation film arranged between the semi-transparent layer and the reflective polarizer; an element separated from the reflective polarizer; and a third retardation film arranged between the reflective polarizer and the element, wherein the first retardation film, the second retardation film, and the third retardation film are quarter-wave plates, and the element has a lens action of condensing first circularly polarized light.

According to another embodiment, a display device includes: a display panel emitting display light of linearly polarized light; a semi-transparent layer; a first retardation film arranged between the display panel and the semi-transparent layer; an element separated from the semi-transparent layer; and a first optical element being arranged between the semi-transparent layer and the element, separated from the semi-transparent layer, containing first cholesteric liquid crystal, reflecting first circularly polarized light toward the semi-transparent layer, and transmitting second circularly polarized light in a reverse direction to the first circularly polarized light, wherein the first retardation film is a quarter-wave plate, and the element has a lens action of condensing the second circularly polarized light.

According to another embodiment, a display device includes: a display panel emitting display light of linearly polarized light; a semi-transparent layer; a first retardation film arranged between the display panel and the semi-transparent layer; a first element being separated from the semi-transparent layer, containing cholesteric liquid crystal, reflecting first circularly polarized light toward the semi-transparent layer, and transmitting second circularly polarized light in a reverse direction to the first circularly polarized light; a second element containing cholesteric liquid crystal, reflecting the second circularly polarized light, and transmitting the first circularly polarized light; and an element separated from the semi-transparent layer and arranged between the first element and the second element, wherein the first retardation film is a quarter-wave plate, the element has a lens action of condensing the second circularly polarized light.

According to another embodiment, a display device includes: a display panel emitting display light of linearly polarized light; a semi-transparent layer; a first retardation film arranged between the display panel and the semi-transparent layer; an element separated from the semi-transparent layer; a first optical element being arranged between the semi-transparent layer and the element, containing first cholesteric liquid crystal, reflecting first circularly polarized light toward the semi-transparent layer, and transmitting second circularly polarized light in a reverse direction to the first circularly polarized light; a polarizer; and a fourth retardation film arranged between the element and the polarizer, wherein the first retardation film and the fourth retardation film are quarter-wave plates, the element has a lens action of condensing the second circularly polarized light.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the drawings, an X-axis, a Y-axis and a Z-axis orthogonal to each other are described in the drawings to facilitate understanding as needed. A direction along the X-axis is referred to as a first direction X, a direction along the Y-axis is referred to as a second direction Y, and a direction along the Z-axis is referred to as a third direction Z. A plane defined by the X-axis and the Y-axis is referred to as an X-Y plane and viewing the X-Y plane is referred to as planar view.

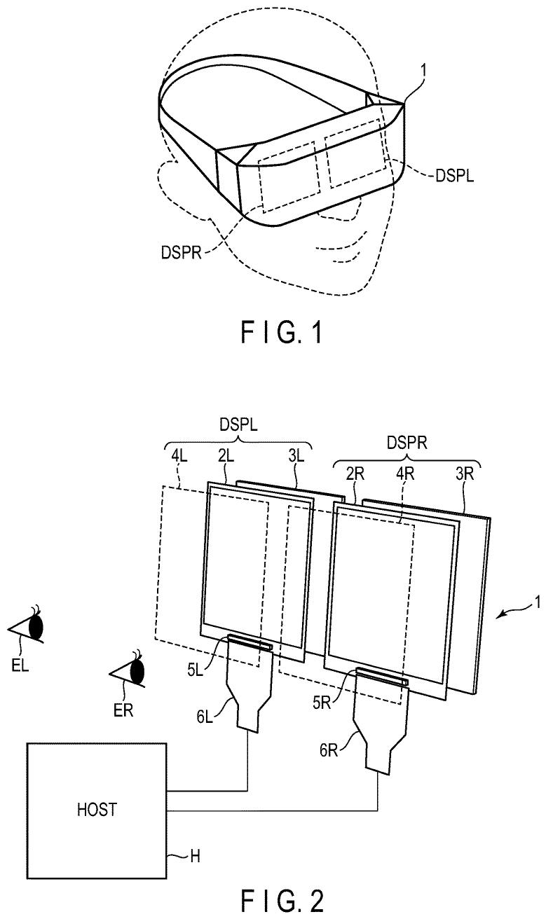

FIG. 1 is a perspective view showing an example of an appearance of a head-mounted display 1 to which a display device of the embodiments is applied. The head-mounted display 1 comprises, for example, a display device DSPR for a right eye and a display device DSPL for a left eye. In a state in which the user wears the head-mounted display 1 on the head, the display device DSPR is arranged to be located in front of the user's right eye, and the display device DSPL is arranged to be located in front of the user's left eye. FIG. 2 is a diagram illustrating a summary of a configuration of the head-mounted display 1 shown in FIG. 1. The display device DSPR is configured substantially similarly to the display device DSPL.

The display device DSPR comprises a display panel 2R, an illumination device 3R, and an optical system 4R represented by a dotted line. The illumination device 3R is arranged on a back surface of the display panel 2R and configured to illuminate the display panel 2R. The optical system 4R is arranged in front of the display panel 2R (or between the user's right eye ER and the display panel 2R) and configured to guide display light from the display panel 2R to the right eye ER.

The display panel 2R is, for example, a liquid crystal panel. The display panel 2R is arranged between the illumination device 3R and the optical system 4R. For example, a driver IC chip 5R and a flexible printed circuit board 6R are connected to the display panel 2R. The driver IC chip 5R controls drive of the display panel 2R (particularly, controls a display action of the display panel 2R).

The display device DSPL comprises a display panel 2L, an illumination device 3L, and an optical system 4L represented by a dotted line. The illumination device 3L is arranged on a back surface of the display panel 2L and configured to illuminate the display panel 2L. The optical system 4L is arranged in front of the display panel 2L (or between the user's left eye EL and the display panel 2L) and configured to guide display light from the display panel 2L to the left eye EL.

The display panel 2L is, for example, a liquid crystal panel. The display panel 2L is arranged between the illumination device 3L and the optical system 4L. For example, a driver IC chip 5L and a flexible printed circuit board 6L are connected to the display panel 2L. The driver IC chip 5L controls drive of the display panel 2L (particularly, controls a display action of the display panel 2L).

The display panel 2R, the illumination device 3R, and the optical system 4R configuring the display device DSPR are configured similarly to the display panel 2L, the illumination device 3L, and the optical system 4L configuring the display device DSPL.

In the display device DSP according to the embodiments, the display panels 2R and 2L are not limited to liquid crystal panels, but may be display panels comprising self-luminous light emitting elements such as organic electroluminescent (EL) devices, micro-LED, and mini-LED. When the display panel is a display panel comprising the light emitting elements, the illumination devices 3R and 3L are omitted.

A host computer H provided outside is connected to each of the display panels 2L and 2R. The host computer H outputs image data corresponding to the images displayed on the display panels 2L and 2R. The image displayed on the display panel 2L is an image for the left eye (or an image to be visually recognized by the user's left eye EL). In addition, the image displayed on the display panel 2R is an image for the right eye (or an image to be visually recognized by the user's right eye ER).

For example, when the head-mounted display 1 is used for VR, the image for the left eye and the image for the right eye are images similar to each other, which reproduce the parallax of both eyes. When the image for the left eye displayed on the display panel 2L is visually recognized by the user's left eye EL and the image for the right eye displayed on the display panel 2R is visually recognized by the user's right eye ER, the user can grasp a stereoscopic space (three-dimensional space) as a virtual reality space.

Next, a first configuration example of the display device DSP according to the embodiments will be described.

### First Configuration Example

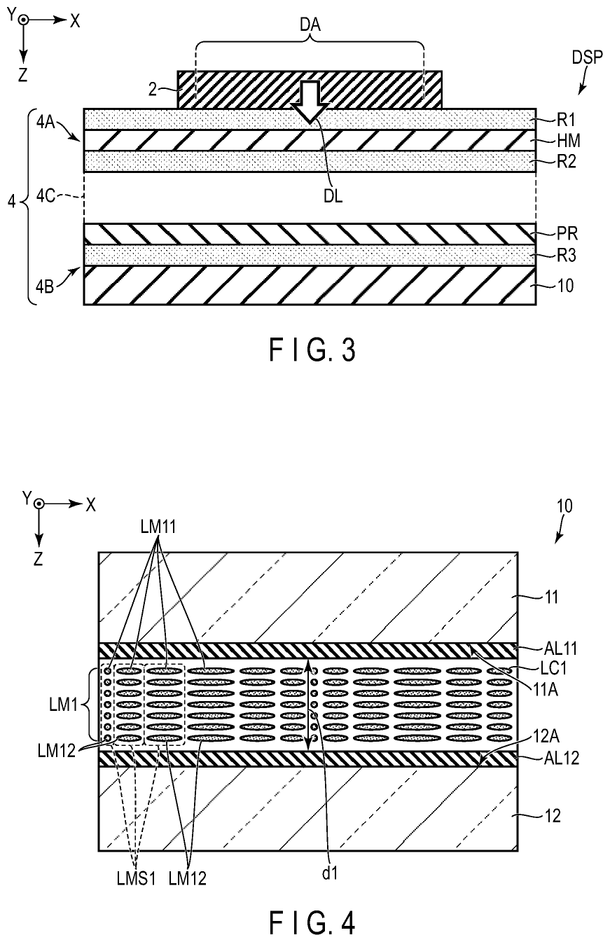

FIG. 3 is a cross-sectional view showing a first configuration example of the display device DSP.

The display device DSP comprises a display panel 2 and an optical system 4. Illustration of the details of the display panel 2 is omitted and illustration of the illumination devices is also omitted. The display device DSP described herein can be applied to each of the display devices DSPR and DSPL. In addition, the display panel 2 can be applied to each of the display panels 2R and 2L. In addition, the optical system 4 can be applied to each of the optical systems 4R and 4L.

The display panel 2 is formed in a flat plate shape extending in the X-Y plane. Details of the display panel 2 will be described later, but is configured to emit display light DL of linearly polarized light in the display region DA. For example, the display panel 2 comprises a polarizer, and the display light DL of the linearly polarized light is emitted via the polarizer.

The display panel 2 is not limited to a liquid crystal panel in not only the first configuration example, but also the other configuration examples. When the display panel 2 is a display panel comprising a self-luminous light emitting element, the illumination device 3 is omitted as described above. In addition, in this case, the display light DL emitted from the light emitting element is transmitted through the polarizer and converted into the display light DL of the linearly polarized light.

The optical system 4 comprises a first structure 4A and a second structure 4B. The first structure 4A is spaced apart from the second structure 4B. In the example shown in FIG. 3, an air layer 4C is provided between the first structure 4A and the second structure 4B. The first structure 4A is arranged between the display panel 2 and the second structure 4B (or between the display panel 2 and the air layer 4C).

The first structure 4A comprises a first retardation film R1, a semi-transparent layer HM, and a second retardation film R2. The first retardation film R1 and the second retardation film R2 are quarter-wave plates, assigning a quarter-wave phase difference to the transmitted light. The semi-transparent layer HM transmits part of the incident light and reflects the other light. For example, the semi-transparent layer HM is a thin film formed of a metal material such as aluminum or silver. In addition, the transmittance of the semi-transparent layer HM is approximately 50%.

The first retardation film R1, the semi-transparent layer HM, and the second retardation film R2 extend in a range wider than the display region DA in the X-Y plane. In addition, the first retardation film R1, the semi-transparent layer HM, and the second retardation film R2 are stacked in this order along the third direction Z. The first retardation film R1 is in contact with the display panel 2, the semi-transparent layer HM is in contact with the first retardation film R1, the second retardation film R2 is in contact with the semi-transparent layer HM, the first retardation film R1 is arranged between the display panel 2 and the semi-transparent layer HM, and the semi-transparent layer HM is arranged between the first retardation film R1 and the second retardation film R2.

The second structure 4B comprises a reflective polarizer PR, a third retardation film R3, and a liquid crystal element 10. The reflective polarizer PR transmits first linearly polarized light of the incident light, and reflects second linearly polarized light orthogonal to the first linearly polarized light. For example, the reflective polarizer PR is a polarizer of a multi-layered thin film type or a wire grid type. The third retardation film R3 is a quarter-wave plate, assigning a quarter-wave phase difference to transmitted light.

The liquid crystal element 10 assigns a half-wave phase difference to light of a specific wavelength and has a lens action of condensing the first circularly polarized light. The liquid crystal element 10 is mentioned as an example of the device having a lens action of condensing the circularly polarized light, but the element is not limited to a device using the liquid crystal if it has an equivalent lens action.

The reflective polarizer PR, the third retardation film R3, and the liquid crystal element 10 extend in a range wider than the display region DA in the X-Y plane. In addition, the reflective polarizer PR, the third retardation film R3, and the liquid crystal element 10 are stacked in this order in the third direction Z. The third retardation film R3 is in contact with the reflective polarizer PR, the liquid crystal element 10 is in contact with the third retardation film R3, the second retardation film R2 is arranged between the semi-transparent layer HM and the reflective polarizer PR, and the third retardation film R3 is arranged between the reflective polarizer PR and the liquid crystal element 10. The reflective polarizer PR is separated from the second retardation film R2 and is opposed to the second retardation film R2 through the air layer 4C in the third direction Z.

The display panel 2 and the first retardation film R1 are desirably in close contact with each other with no air layer interposed therebetween. In addition, the first retardation film R1, the semi-transparent layer HM, and the second retardation film R2 constructing the first structure 4A are desirably in close contact with one another with no air layer interposed between. Furthermore, the reflective polarizer PR, the third retardation film R3, and the liquid crystal element 10 constructing the second structure 4B are desirably in close contact with one another with no air layer interposed between. Undesired reflection or refraction in the interface between the members can be thereby suppressed.

The first retardation film R1, the second retardation film R2, and the third retardation film R3 assign a quarter-wave phase difference to, for example, light of at least the green wavelength, but are not limited to this type. For example, wide-band retardation films assigning an approximately quarter-wave phase difference to light of the red wavelength, the green wavelength, and the blue wavelength can be applied as the first retardation film R1, the second retardation film R2, and the third retardation film R3. As such a wide-band type retardation film, for example, a retardation film formed by bonding a quarter-wave plate and a half-wave plate in a state in which a slow axis of the quarter-wave plate and a slow axis of the half-wave plate forms a predetermined angle can be applied. The wavelength dependency in the first retardation film R1, the second retardation film R2, and the third retardation film R3 can be thereby relaxed.

FIG. 4 is a cross-sectional view showing an example of a liquid crystal element 10 shown in FIG. 3. The liquid crystal element 10 comprises a substrate 11, an alignment film AL11, a liquid crystal layer (first liquid crystal layer) LC1, an alignment film AL12, and a substrate 12.

The substrates 11 and 12 are transparent substrates that transmit light and are composed of, for example, transparent glass plates or transparent synthetic resin plates. The substrate 11 is bonded to, or example, the third retardation film R3 shown in FIG. 3 but may be replaced with the third retardation film R3.

The alignment film AL11 is arranged on an inner surface 11A of the substrate 11. In the example shown in FIG. 4, the alignment film AL11 is in contact with the substrate 11, but the other thin film may be interposed between the alignment film AL11 and the substrate 11.

The alignment film AL12 is arranged on an inner surface 12A of the substrate 12. In the example shown in FIG. 4, the alignment film AL12 is in contact with the substrate 12, but the other thin film may be interposed between the alignment film AL12 and the substrate 12. The alignment film AL12 is opposed to the alignment film AL11 in the third direction Z.

Each of the alignment films AL11 and AL12 is, for example, a horizontal alignment film which is formed of polyimide and which has an alignment restriction force along the X-Y plane.

The liquid crystal layer LC1 is arranged between the alignment films AL11 and AL12 and is in contact with the alignment films AL11 and AL12. The liquid crystal layer LC1 has a thickness d1 along the third direction Z. The liquid crystal layer LC1 has the nematic liquid crystal which has the alignment direction aligned with the third direction Z.

That is, the liquid crystal layer LC1 includes a plurality of liquid crystal structures LMS1. When one liquid crystal structure LMS1 is focused, the liquid crystal structure LMS1 contains liquid crystal molecules LM11 located on one end side and liquid crystal molecules LM12 on the other end side. The liquid crystal molecules LM11 are close to the alignment film AL11, and the liquid crystal molecules LM12 are close to the alignment film AL12. The alignment directions of the liquid crystal molecules LM11 are substantially coincident with the alignment directions of the liquid crystal molecules LM12. In addition, the alignment directions of the other liquid crystal molecules LM1 between the liquid crystal molecules LM11 and the liquid crystal molecules LM12 are also substantially coincident with the alignment directions of the liquid crystal molecules LM11. The alignment directions of the liquid crystal molecules LM1 correspond to the longer axes of the liquid crystal molecules in the X-Y plane.

In addition, in the liquid crystal layer LC1, a plurality of liquid crystal structures LMS1 adjacent in the first direction X have alignment directions different from each other. Similarly, a plurality of liquid crystal structures LMS1 adjacent in the second direction Y have alignment directions different from each other. The alignment directions of the plurality of liquid crystal molecules LM11 arranged along the alignment film AL11 and the alignment directions of the plurality of liquid crystal molecules LM12 arranged along the alignment film AL12 are changed continuously (or linearly).

Such a liquid crystal layer LC1 is cured in a state in which the alignment directions of the liquid crystal molecules LM1 containing the liquid crystal molecules LM11 and the liquid crystal molecules LM12 are fixed. In other words, the alignment directions of the liquid crystal molecules LM1 are not controlled depending on the electric field. For this reason, the liquid crystal element 10 does not comprise an electrode for controlling the alignment.

When the refractive anisotropy or birefringence (difference between a refractive index ne to extraordinary light and a refractive index no to ordinary light in the liquid crystal layer LC1) of the liquid crystal layer LC1 is referred to as Δn, retardation (phase difference) Δn·d1 of the liquid crystal layer LC1 is set to ½ of the specific wavelength λ.

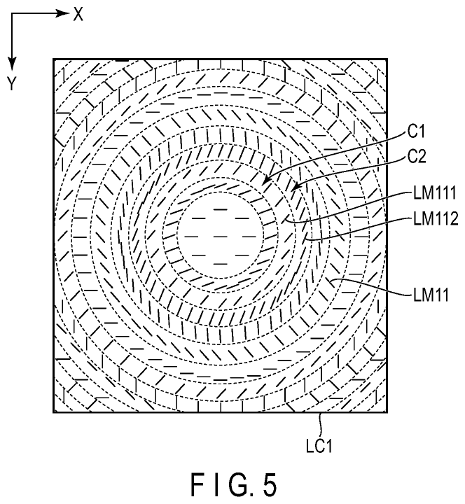

FIG. 5 is a plan view showing an example of an alignment pattern in a liquid crystal layer LC1 shown in FIG. 4. An example of the spacial phase in the X-Y plane of liquid crystal layer LC1 is shown in FIG. 5. The spacial phase shown herein is shown as the alignment directions of the liquid crystal molecules LM11 close to the alignment film AL11, of the liquid crystal molecules LM1 contained in the liquid crystal structure LMS1.

Spatial phases are aligned in concentric circles represented by dotted lines in the drawing. Alternatively, the alignment directions of the liquid crystal molecules LM11 are aligned in an annular region surrounded by two adjacent concentric circles. However, the alignment directions of the liquid crystal molecules LM11 in the adjacent annular regions are different from each other.

For example, the liquid crystal layer LC1 includes a first annular region C1 and a second annular region C2 in planar view. The second annular region C2 is located outside the first annular region C1. The first annular region C1 is configured by a plurality of first liquid crystal molecules LM111 aligned in the same direction. In addition, the second annular region C2 is configured by a plurality of second liquid crystal molecules LM112 aligned in the same direction. The alignment direction of the first liquid crystal molecules LM111 is different from the alignment direction of the second liquid crystal molecules LM112.

Similarly, the alignment directions of the liquid crystal molecules LM11 arranged in a radial direction from the central region of the concentric circles are different from each other and are varied continually. That is, the spatial phases of the liquid crystal layer LC1 are different in the radial direction and are varied continuously in the X-Y plane shown in the drawing.

When the first circularly polarized light is made incident on the liquid crystal element 10 thus configured, the first circularly polarized light is condensed towards the center of the concentric circles, and the transmitted light of the liquid crystal element 10 is converted into the second circularly polarized light of the opposite direction to the first circularly polarized light.

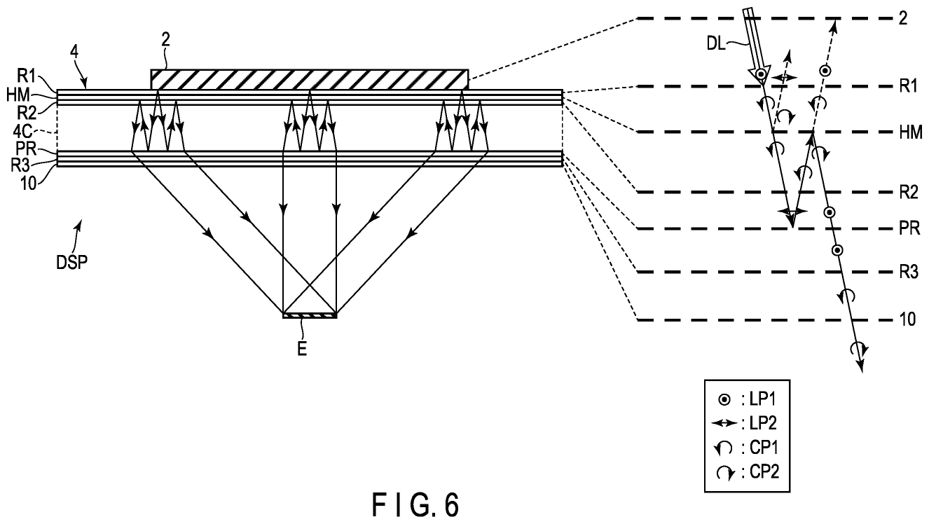

FIG. 6 is a view illustrating an optical action of the display device DSP.

First, the display panel 2 emits the display light DL of the first linearly polarized light LP1. In this example, the first linearly polarized light LP1 is, for example, the linearly polarized light oscillated in a direction perpendicular to a sheet surface. In addition, the display light DL is the light of a specific wavelength λ. The display light DL is assigned a quarter-wave phase difference when transmitted through the first retardation film R1. The display light DL is thereby converted into first circularly polarized light CP1 when transmitted through the first retardation film R1. In this example, the first circularly polarized light CP1 is, for example, left-handed circularly polarized light.

Part of the first circularly polarized light CP1 transmitted through the first retardation film R1 is transmitted through the semi-transparent layer HM and the other part of the first circularly polarized light CP1 is reflected on the semi-transparent layer HM. The first circularly polarized light CP1 transmitted through the semi-transparent layer HM is assigned a quarter-wave phase difference and is converted into second linearly polarized light LP2 when transmitted through the second retardation film R2. In this example, the second linearly polarized light LP2 is the linearly polarized light oscillated in a direction orthogonal to the first linearly polarized light LP1, i.e., a direction parallel to a sheet surface.

When the first circularly polarized light CP1 is reflected on the semi-transparent layer HM, the first circularly polarized light CP1 is converted into the second circularly polarized light CP2 turning in a reverse direction to the first circularly polarized light CP1. In this case, the second circularly polarized light CP2 is, for example, right-handed circularly polarized light. The second circularly polarized light CP2 reflected on the semi-transparent layer HM is transmitted through the first retardation film R1 and converted into the second linearly polarized light LP2, which is absorbed into the display panel 2.

The second linearly polarized light LP2 transmitted through the second retardation film R2 is reflected on the reflective polarizer PR. The second linearly polarized light LP2 reflected on the reflective polarizer PR is transmitted through the second retardation film R2 and converted into the first circularly polarized light CP1.

Part of the first circularly polarized light CP1 transmitted through the second retardation film R2 is reflected on the semi-transparent layer HM, and the other part of the first circularly polarized light CP1 is transmitted through the semi-transparent layer HM. The first circularly polarized light CP1 is converted into the second circularly polarized light CP2 when reflected on the semi-transparent layer HM. The second circularly polarized light CP2 reflected on the semi-transparent layer HM is transmitted through the second retardation film R2 and converted into the first linearly polarized light LP1.

The first circularly polarized light CP1 transmitted through the semi-transparent layer HM is transmitted through the first retardation film R1 and converted into the first linearly polarized light LP1.

The first linearly polarized light LP1 transmitted through the second retardation film R2 is transmitted through the reflective polarizer PR, further transmitted through the third retardation film R3, and converted into the first circularly polarized light CP1. The first circularly polarized light CP1 transmitted through the third retardation film R3 is converted into the second circularly polarized light CP2, which is condensed to user's pupil E by the lens action in the liquid crystal element 10.

According to such a display device DSP, the optical system 4 includes an optical path which passes three times between the semi-transparent layer HM and the reflective polarizer PR. In other words, in the optical system 4, an optical distance between the semi-transparent layer HM and the reflective polarizer PR is approximately three times as large as an actual distance between the semi-transparent layer HM and the reflective polarizer PR (or thickness of the air layer 4C). The display panel 2 is installed on an inner side than a focus of the liquid crystal element 10 having the lens action. The user can thereby observe an extended virtual image.

In addition, according to the first configuration example, the thickness in the third direction Z can be reduced and the weight reduction can be implemented as compared with an optical system comprising optical components formed of glass, resin, and the like.

The first linearly polarized light LP1 described with reference to FIG. 6 may be replaced with the second linearly polarized light LP2 or the first circularly polarized light CP1 may be replaced with the second circularly polarized light CP2.

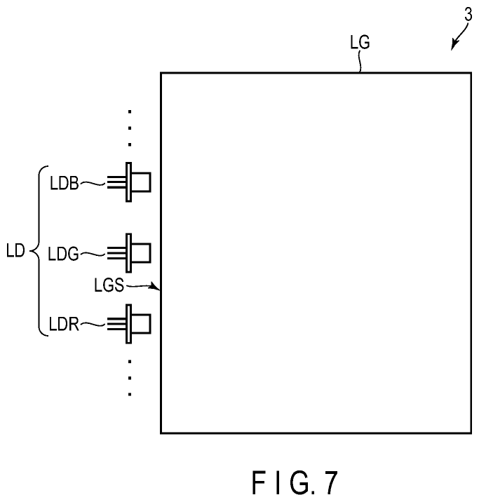

FIG. 7 is a plan view showing a configuration example of an illumination device 3 applicable to the display device DSP shown in FIG. 3. Only main portions of the illumination device 3 are shown in FIG. 7.

The illumination device 3 comprises a light guide LG and a plurality of light emitting elements LD. Each of the plurality of light emitting elements is opposed to a side surface LGS of the light guide LG. The light emitting element LD includes a first light emitting element LDB emitting light of a blue wavelength (first wavelength), a second light emitting element LDG emitting light of a green wavelength (second wavelength), and a third light emitting element LDR emitting light of a red wavelength (third wavelength). The first light emitting element LDB, the second light emitting element LDG, and the third light emitting element LDR are arranged with intervals.

The light emitted from the light emitting element LD desirably has a narrow spectral width (or a high color purity). For this reason, a laser light source is desirably used as the light emitting element LD. A center wavelength of the blue laser light emitted from the first light emitting element (first laser element) LDB is referred to as kb, a center wavelength of the green laser light emitted from the second light emitting element (second laser element) LDG is referred to as λg, and a center wavelength of the red laser light emitted from the third light emitting element (third laser element) LDR is referred to as kr.

The illumination device 3 is not limited to the structure shown in FIG. 7, but may be a direct type illumination device in which the light emitting element LD is arranged just under the display panel.

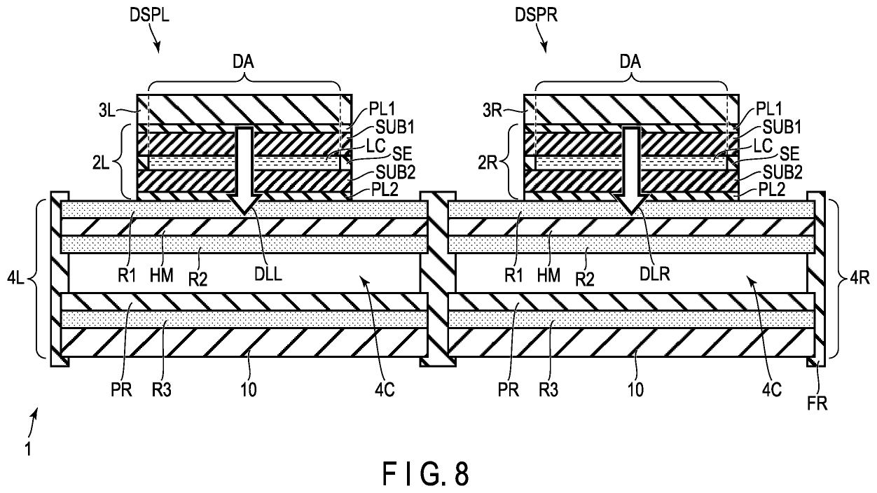

FIG. 8 is a cross-sectional view showing a first configuration example of the head-mounted display 1. The head-mounted display 1 comprises the display device DSPR for a right eye, the display device DSPL for a left eye, and a frame FR holding the display devices DSPR and DSL.

The illumination device 3L in the display device DSPL corresponds to the illumination device 3 described with reference to FIG. 7, and comprises the first light emitting element LDB emitting blue laser light of the center wavelength λb, the second light emitting element LDG emitting green laser light of the center wavelength λg, and the third light emitting element LDR emitting red laser light of the center wavelength λr.

The display panel 2L in the display device DSPL comprises a first substrate SUB1, a second substrate SUB2, a liquid crystal layer LC, a polarizer PL1, and a polarizer PL2. The liquid crystal layer LC is held between the first substrate SUB1 and the second substrate SUB2, and is sealed by a seal SE. The first polarizer PL1 is arranged between the illumination device 3L and the first substrate SUB1. The second polarizer PL2 is arranged between the second substrate SUB2 and the first retardation film R1 of the optical system 4L.

The display region DA of the display panel 2L is configured to selectively modulate the illumination light from the illumination device 3L. Part of the illumination light is transmitted through the second polarizer PL2 and converted into the display light DLL of the linearly polarized light for a left eye.

The optical system 4L in the display device DSPL comprises the first retardation film R1, the semi-transparent layer HM, the second retardation film R2, the reflective polarizer PR, the third retardation film R3, and the liquid crystal element 10. The first retardation film R1, the semi-transparent layer HM, the second retardation film R2, the reflective polarizer PR, and the third retardation film R3 have been described with reference to FIG. 3 and the like.

The liquid crystal element 10 assigns, for example, a half-wave phase difference to the light of the green wavelength (second wavelength) λg and has a lens action of condensing at least the first circularly polarized light of the green wavelength λg. In other words, the retardation of the liquid crystal element 10 is optimized to correspond to the center wavelength λg of the green laser light emitted from the second light emitting element LDG of the illumination device 3L. The liquid crystal element 10 applied to the embodiments also has a lens action of condensing the first circularly polarized light of not only the green wavelength λg, but also the blue wavelength λb and the red wavelength λr.

The illumination device 3R in the display device DSPR corresponds to the illumination device 3 described with reference to FIG. 7.

The display panel 2R in the display device DSPR is configured similarly to the display device 2L, and comprises a first substrate SUB1, a second substrate SUB2, a liquid crystal layer LC, a polarizer PL1, and a polarizer PL2. The display region DA of the display panel 2R is configured to selectively modulate the illumination light from the illumination device 3R. Part of the illumination light is transmitted through the second polarizer PL2 and converted into the display light DLR of the linearly polarized light for a right eye.

The optical system 4R in the display device DSPR is configured similarly to the optical system 4L, and comprises the first retardation film R1, the semi-transparent layer HM, the second retardation film R2, the reflective polarizer PR, the third retardation film R3, and the liquid crystal element 10.

In such a head-mounted display 1, the display light DLL of the display device DSPL is condensed to the user's left eye, and the display light DLR of the display device DSPR is condensed to the user's right eye.

According to such a first configuration example, the illumination device 3 comprises the laser light source which emits the light of a narrow spectral width, and the liquid crystal element 10 is optimized in accordance with the center wavelength of the light emitted from the laser light source. Thus, light of a specific wavelength can be condensed efficiently, a chromatic aberration can be reduced, and a clear image can be visually recognized by the user.

Next, the other configuration examples of the display device DSP according to the embodiments will be described. The same constituent elements as those of the first configuration example are denoted by the same reference numerals and their explanations may be omitted.

### Second Configuration Example

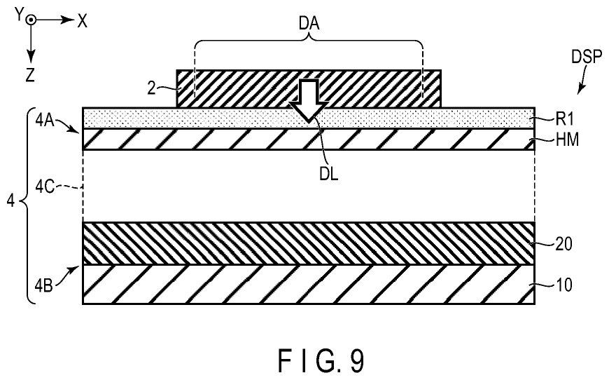

FIG. 9 is a cross-sectional view showing a second configuration example of the display device DSP. The second configuration example shown in FIG. 9 is different from the first configuration example shown in FIG. 3 in that the second retardation film R2, the reflective polarizer PR, and the third retardation film R3 are replaced with an optical device 20.

The display device DSP comprises a display panel 2 and an optical system 4. Details of the display panel 2 are omitted here, but the display panel 2 is configured to emit display light DL of linearly polarized light in the display region DA.

The first structure 4A of the optical system 4 comprises the first retardation film R1 and the semi-transparent layer HM. The first retardation film R1 is a quarter-wave plate. The semi-transparent layer HM transmits part of the incident light and reflects the other light.

The first retardation film R1 and the semi-transparent layer HM are stacked in this order along the third direction Z. The first retardation film R1 is in contact with the display panel 2, the semi-transparent layer HM is in contact with the first retardation film R1, and the first retardation film R1 is arranged between the display panel 2 and the semi-transparent layer HM.

The second structure 4B of the optical system 4 comprises the optical element (first optical element) 20 and the liquid crystal element 10. The optical element 20 contains cholesteric liquid crystal (first cholesteric liquid crystal), which will be described later in detail. The optical element 20 reflects the first circularly polarized light of the first-wavelength light to the semi-transparent layer HM and transmits the second circularly polarized light. The liquid crystal element 10 assigns a half-wave phase difference to the light of a specific wavelength and has a lens action of condensing the second circularly polarized light.

The second element 20 and the liquid crystal element 10 are stacked in this order along the third direction Z. The liquid crystal element 10 is in contact with the optical element 20. The optical element 20 is separated from the semi-transparent layer HM, and is opposed to the semi-transparent layer HM through the air layer 4C in the third direction Z. In addition, the optical element 20 is arranged between the semi-transparent layer HM and the liquid crystal element 10.

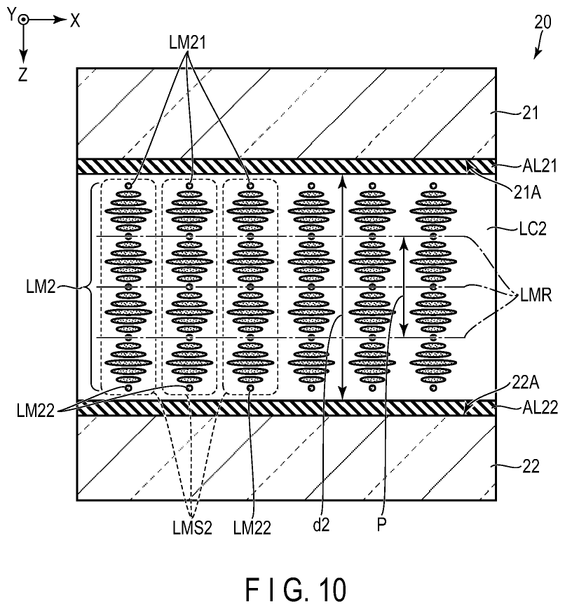

FIG. 10 is a cross-sectional view showing an example of an optical element 20 shown in FIG. 9. The optical element 20 comprises a substrate 21, an alignment film AL21, a liquid crystal layer (second liquid crystal layer) LC2, an alignment film AL22, and a substrate 22.

The substrates 21 and 22 are transparent substrates that transmit light and are composed of, for example, transparent glass plates or transparent synthetic resin plates. The substrate 22 is bonded to, for example, the liquid crystal element 10 shown in FIG. 9 but may be replaced with the substrate 11 of the liquid crystal element 10.

The alignment film AL21 is arranged on an inner surface 21A of the substrate 21. In the example shown in FIG. 10, the alignment film AL21 is in contact with the substrate 21, but the other thin film may be interposed between the alignment film AL21 and the substrate 21.

The alignment film AL22 is arranged on an inner surface 22A of the substrate 22. In the example shown in FIG. 10, the alignment film AL22 is in contact with the substrate 22, but the other thin film may be interposed between the alignment film AL22 and the substrate 22. The alignment film AL22 is opposed to the alignment film AL21 in the third direction Z.

Each of the alignment films AL21 and AL22 is, for example, a horizontal alignment film which is formed of polyimide and which has an alignment restriction force along the X-Y plane.

The liquid crystal layer LC2 is arranged between the alignment films AL21 and AL22 and is in contact with the alignment films AL21 and AL22. The liquid crystal layer LC2 has a thickness d2 along the third direction Z. The liquid crystal layer LC2 contains cholesteric liquid crystal. To simplify the illustration, in FIG. 10, one liquid crystal molecule LM2 represents a liquid crystal molecule facing in the average alignment direction, of the plurality of liquid crystal molecules located in the X-Y plane.

That is, the liquid crystal layer LC2 includes a plurality of liquid crystal structures LMS2. When one liquid crystal structure LMS2 is focused, the liquid crystal structure LMS2 contains liquid crystal molecules LM21 located on one end side and liquid crystal molecules LM22 on the other end side. The liquid crystal molecules LM21 are close to the alignment film AL21, and the liquid crystal molecules LM22 are close to the alignment film AL22. The plurality of liquid crystal molecules LM2 containing the liquid crystal molecule LM21 and the liquid crystal molecule LM22 are stacked along the third direction Z in a spiral state while turning to construct the cholesteric liquid crystal. The alignment directions of the liquid crystal molecules LM21 are substantially coincident with the alignment directions of the liquid crystal molecules LM22. The liquid crystal structure LMS2 has a helical pitch P. The helical pitch P indicates one period (360 degrees) of the spiral. For example, the thickness d2 of the liquid crystal layer LC2 is several times or more as large as the helical pitch P.

In addition, in the liquid crystal layer LC2, a plurality of liquid crystal structures LMS2 adjacent in the first direction X have alignment directions similar to each other. Similarly, a plurality of liquid crystal structures LMS2 adjacent in the second direction Y have alignment directions similar to each other. That is, the alignment directions of the plurality of liquid crystal molecules LM21 arranged along the alignment film AL21 are substantially coincident with each other, and the alignment directions of the plurality of liquid crystal molecules LM22 arranged along the alignment film AL22 are substantially coincident with each other.

The liquid crystal layer LC2 has a plurality of reflective planes LMR as represented by one-dot chain lines, between the alignment film AL21 and the alignment film AL22. The plurality of reflective planes LMR are formed along the X-Y plane and are substantially parallel to each other. The reflective planes LMR are formed along the X-Y plane. The reflective planes LMR reflect a part of the circularly polarized light of the incident light and transmit the other part of the circularly polarized light according to the Bragg's law. The reflective planes LMR correspond to planes where alignment directions of the liquid crystal molecules LM2 are aligned or planes (equiphase wave surfaces) where the spatial planes are aligned.

The liquid crystal structure LMS2 reflects the circularly polarized light of the same turning direction as the turning direction of the cholesteric liquid crystal of the light of the first wavelength λ. For example, when the turning direction of the cholesteric liquid crystal is right-handed, the liquid crystal structure LMS2 reflects the right-handed circularly polarized light of the light of the first wavelength 2 and transmits the left-handed circularly polarized light. Similarly, when the turning direction of the cholesteric liquid crystal is left-handed, the liquid crystal structure LMS2 reflects the left-handed circularly polarized light of the light of the first wavelength λ and transmits the right-handed circularly polarized light.

Such a liquid crystal layer LC2 is cured in a state in which the alignment directions of the liquid crystal molecules LM2 containing the liquid crystal molecules LM21 and the liquid crystal molecules LM22 are fixed. In other words, the alignment directions of the liquid crystal molecules LM2 are not controlled depending on the electric field. For this reason, the optical element 20 does not comprise an electrode for controlling the alignment.

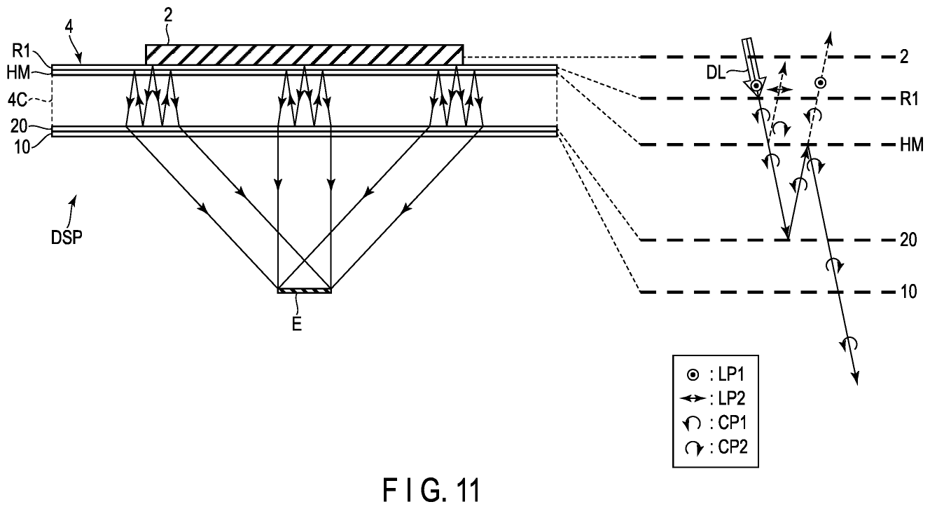

When the helical pitch of the cholesteric liquid crystal is referred to as P, the refractive index of the liquid crystal molecules to extraordinary light is referred to as ne, and the refractive index of the liquid crystal molecules to ordinary light is referred to as no, a selective reflection region Δλ of the cholesteric liquid crystal to the perpendicularly incident light is generally referred to as “no*P to ne*P”. For this reason, to reflect the circularly polarized light of the first wavelength λ on the reflective planes LMR, the helical pitch P, the refractive and the indexes ne and no are set such that the first wavelength λ is included in the selective reflection wavelength band FIG. 11 is a view illustrating an optical action of the display device DSP.

First, the display panel 2 emits the display light DL of the first linearly polarized light LP1. The display light DL is the light of the first wavelength λ. The display light DL is transmitted through the first retardation film R1 and converted into the first circularly polarized light CP1.

Part of the first circularly polarized light CP1 transmitted through the first retardation film R1 is transmitted through the semi-transparent layer HM and the other part of the first circularly polarized light CP1 is reflected on the semi-transparent layer HM. The first circularly polarized light CP1 transmitted through the semi-transparent layer HM is reflected on the optical element 20.

The first circularly polarized light CP1 is converted into the second circularly polarized light CP2 when reflected on the semi-transparent layer HM. The second circularly polarized light CP2 reflected on the semi-transparent layer HM is transmitted through the first retardation film R1 and converted into the second linearly polarized light LP2, which is absorbed into the display panel 2.

Part of the first circularly polarized light CP1 reflected on the optical element 20 is transmitted through the semi-transparent layer HM and the other part of the first circularly polarized light CP1 is reflected on the semi-transparent layer HM. The first circularly polarized light CP1 is converted into the second circularly polarized light CP2 when reflected on the semi-transparent layer HM.

The first circularly polarized light CP1 transmitted through the semi-transparent layer HM is transmitted through the first retardation film R1 and converted into the first linearly polarized light LP1.

The second circularly polarized light CP2 reflected on the semi-transparent layer HM is transmitted through the optical element 20. The second circularly polarized light CP2 transmitted through the optical element 20 is converted into the first circularly polarized light CP1 in the first element L1 and is condensed to the user's pupil E by the lens action.

In the second configuration example, too, the same advantages as those of the above-described first configuration example can be obtained. In addition, the number of the components configuring the optical system 4 can be reduced.

The first linearly polarized light LP1 described with reference to FIG. 11 may be replaced with the second linearly polarized light LP2 or the first circularly polarized light CP1 may be replaced with the second circularly polarized light CP2.

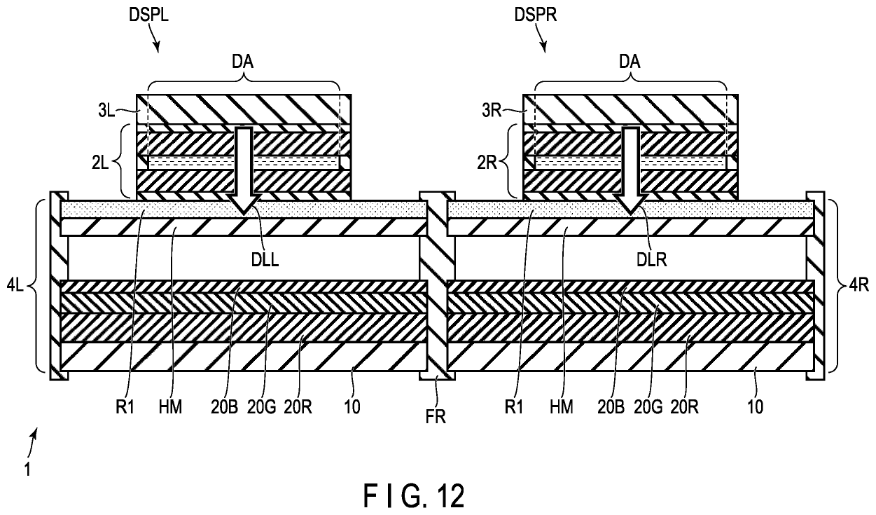

FIG. 12 is a cross-sectional view showing a second configuration example of the head-mounted display 1. The head-mounted display 1 comprises the display device DSPR for a right eye, the display device DSPL for a left eye, and a frame FR holding the display devices DSPR and DSL. The second configuration example shown in FIG. 12 is different from the first configuration example shown in FIG. 8 in that the second retardation film R2, the reflective polarizer PR, and the third retardation film R3 are omitted and a first optical element 20B, a second optical element 20G, and a third optical element 20R are provided.

The illumination device 3L in the display device DSPL and the illumination device 3R in the display device DSPR correspond to the illumination device 3 described with reference to FIG. 7.

The display panel 2L in the display device DSPL and the display panel 2R in the display device DSPR are the same as those of the first configuration example shown in FIG. 8 and their descriptions are omitted.

Each of the optical system 4L in the display device DSPL and the optical system 4R in the display device DSPR comprises the first retardation film R1, the semi-transparent layer HM, the first optical element 20B, the second optical element 20G, the third optical element 20R, and the liquid crystal element 10. The first retardation film R1 and the semi-transparent layer HM have been described with reference to FIG. 3 and the like. The liquid crystal element 10 has been described with reference to FIG. 8.

The first optical element 20B, the second optical element 20G, and the third optical element 20R in each of the display device DSPL and the display device DSPR are stacked in the third direction Z. The order of stacking the first optical element 20B, the second optical element 20G, and the third optical element 20R is not limited to the example shown in the drawing. The first optical element 20B, the second optical element 20G, and the third optical element 20R are equivalent to the optical element 20 described with reference to FIG. 10.

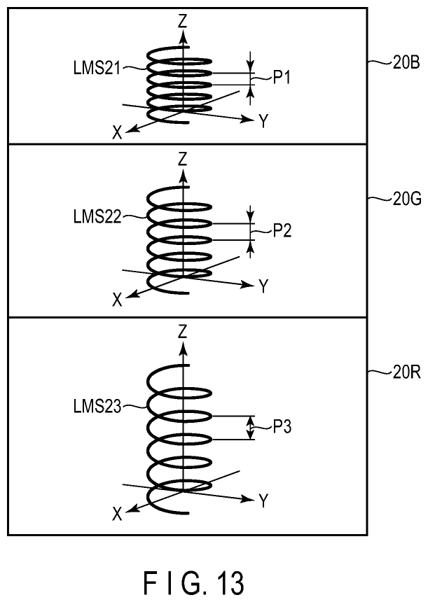

However, the first optical element 20B is configured to reflect the first circularly polarized light of the blue wavelength (first wavelength) λb and transmit the second circularly polarized light of the blue wavelength λb. In other words, a first helical pitch P1 of a liquid crystal structure (first cholesteric liquid crystal) LMS2l included in the first optical element 20B is optimized to correspond to the center wavelength λb of the blue laser light emitted from the first light emitting element LDB of the illumination device 3 as shown in FIG. 13.

In addition, the second optical element 20G is configured to reflect the first circularly polarized light of the green wavelength (second wavelength) 2g and transmit the second circularly polarized light of the green wavelength λg. In other words, a second helical pitch P2 of a liquid crystal structure (second cholesteric liquid crystal) LMS22 included in the second optical element 20G is optimized to correspond to the center wavelength λg of the green laser light emitted from the second light emitting element LDG of the illumination device 3 as shown in FIG. 13. For this reason, the second helical pitch P2 in the second optical element 20G is larger than the first helical pitch P1 in the first optical element 20B.

Furthermore, the third optical element 20R is configured to reflect the first circularly polarized light of the red wavelength (third wavelength) λr and transmit the second circularly polarized light of the red wavelength λr. In other words, a third helical pitch P3 of a liquid crystal structure (third cholesteric liquid crystal) LMS23 included in the third optical element 20R is optimized to correspond to the center wavelength λr of the red laser light emitted from the third light emitting element LDR of the illumination device 3 as shown in FIG. 13. For this reason, the third helical pitch P3 in the third optical element 20R is larger than the second helical pitch P2 in the second optical element 20G.

The cholesteric liquid crystal turning in a first turning direction is schematically shown and enlarged in FIG. 13. All the first cholesteric liquid crystal LMS21, the second cholesteric liquid crystal LMS22, and the third cholesteric liquid crystal LMS23 are configured to turn in the same direction and reflect the left-handed first circularly polarized light.

Thus, when the wavelength λb of the circularly polarized light emitted from the first optical element 20B is referred to as a first wavelength, the second optical element 20G is configured to reflect the circularly polarized light of the second wavelength λg longer than the first wavelength λb, and the third optical element 20R is configured to reflect the circularly polarized light of the third wavelength λr longer than the second wavelength λg.

In such a head-mounted display 1, the display light DLL of the display device DSPL is condensed to the user's left eye, and the display light DLR of the display device DSPR is condensed to the user's right eye.

In the second configuration example, too, the same advantages as those of the above-described first configuration example can be obtained.

### Third Configuration Example

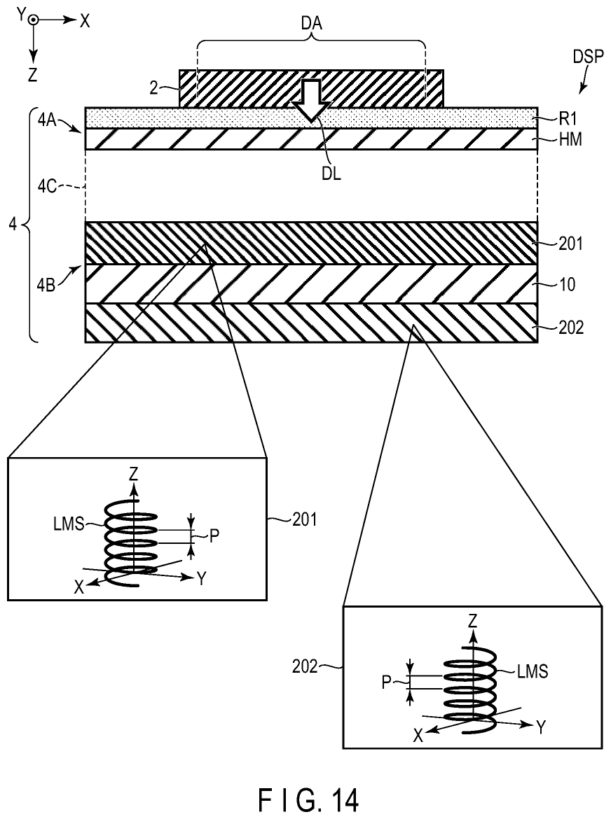

FIG. 14 is a cross-sectional view showing a third configuration example of the display device DSP. The third configuration example shown in FIG. 14 is different from the second configuration example shown in FIG. 9 in comprising a pair of a first element 201 and a second element 202 that sandwich the liquid crystal element 10. The first element 201 and the second element 202 are equivalent to the optical element 20 described with reference to FIG. 10.

The first element 201 includes the liquid crystal structure (cholesteric liquid crystal) LMS turning in the first turning direction while the second element 202 includes the liquid crystal structure (cholesteric liquid crystal) LMS turning in the second turning direction reverse to the first turning direction. The helical pitch P in the first element 201 is the same as the helical pitch P in the second element 202.

Thus, for example, the first element 201 reflects the first circularly polarized light and transmits the second circularly polarized light. In addition, the second element 202 reflects the second circularly polarized light and transmits the first circularly polarized light.

The first element 201, the liquid crystal element 10, and the second element 202 are stacked in this order along the third direction Z. The liquid crystal element 10 is in contact with the first element 201, and the second element 202 is in contact with the liquid crystal element 10. The first element 201 is separated from the semi-transparent layer HM, and is opposed to the semi-transparent layer HM through the air layer 4C in the third direction Z. In addition, the first element 201 is arranged between the semi-transparent layer HM and the liquid crystal element 10, and the liquid crystal element 10 is arranged between the first element 201 and the second element 202.

When the display device DSP shown in FIG. 14 is applied to the head-mounted display 1, each of the first element 201 and the second element 202 is optimized to correspond to the blue wavelength (first wavelength) λb, the green wavelength (second wavelength) λg, and the red wavelength (third wavelength) λr.

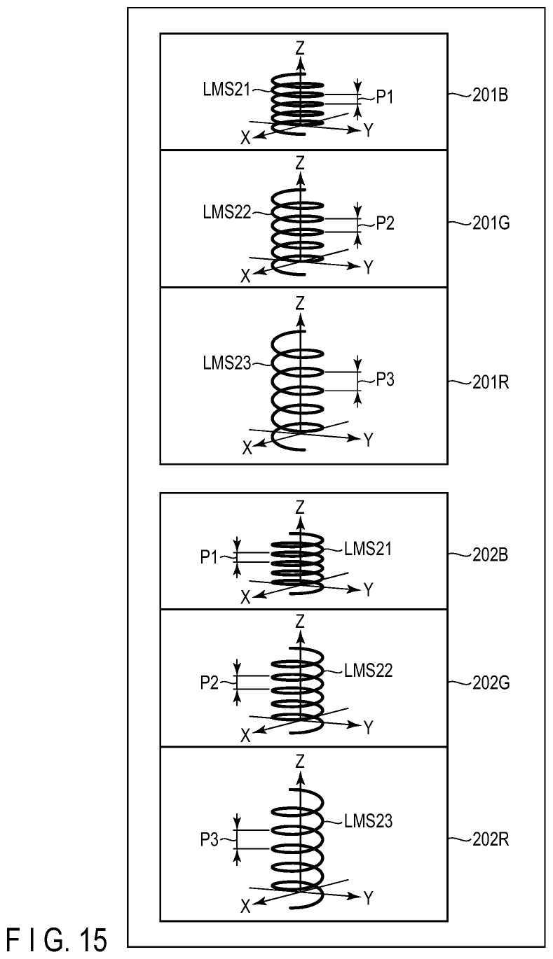

For example, as shown in FIG. 15, a first optical element 201B, a second optical element 2016, and a third optical element 201R are stacked in the first element 201. In addition, a first optical element 202B, a second optical element 202G, and a third optical element 202R are stacked in the second element 202.

The first optical element 201B and the second element 202B are configured to reflect part of the circularly polarized light of the blue wavelength (first wavelength) λb and transmit the other part of the circularly polarized light of the blue wavelength λb. In other words, a first helical pitch P1 of a liquid crystal structure (first cholesteric liquid crystal) LMS21 included in each of the first optical element 201B and 202B is optimized to correspond to the center wavelength λb of the blue laser light emitted from the first light emitting element LDB of the illumination device 3 as shown in FIG. 15.

The second optical elements 201G and 202G are configured to reflect part of the circularly polarized light of the green wavelength (second wavelength) λg and transmit the other part of the circularly polarized light of the green wavelength λg. In other words, a second helical pitch P2 of a liquid crystal structure (second cholesteric liquid crystal) LMS22 included in each of the second optical elements 201G and 202G is optimized to correspond to the center wavelength λg of the green laser light emitted from the second light emitting element LDG of the illumination device 3 as shown in FIG. 15. For this reason, the second helical pitch P2 is larger than the first helical pitch P1.

The third optical element 201R and 202R are configured to reflect part of the circularly polarized light of the red wavelength (third wavelength) λr and transmit the other part of the circularly polarized light of the red wavelength λr. In other words, a third helical pitch P3 of a liquid crystal structure (third cholesteric liquid crystal) LMS23 included in each of the third optical elements 201R and 202R is optimized to correspond to the center wavelength λr of the red laser light emitted from the third light emitting element LDR of the illumination device 3 as shown in FIG. 15. For this reason, the third helical pitch P3 is larger than the second helical pitch P2.

In FIG. 15, all of the first cholesteric liquid crystal LMS21 of the first optical element 201B, the second cholesteric liquid crystal LMS22 of the second optical element 201G, and the third cholesteric liquid crystal LMS23 of the third optical element 201R are configured to turn in the same direction, i.e., the first turning direction, reflect the left-handed first circularly polarized light, and transmit the right-handed second circularly polarized light.

In contrast, all of the first cholesteric liquid crystal LMS21 of the first optical element 202B, the second cholesteric liquid crystal LMS22 of the second optical element 202G, and the third cholesteric liquid crystal LMS23 of the third optical element 202R are configured to turn in the same direction, i.e., the second turning direction, reflect the right-handed second circularly polarized light, and transmit the left-handed first circularly polarized light.

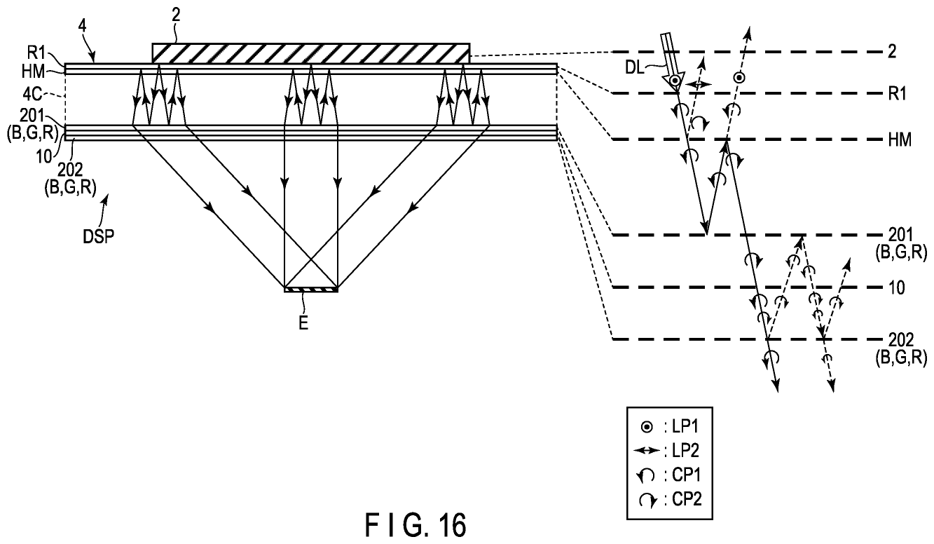

FIG. 16 is a view illustrating an optical action of the display device DSP. 201 (B, G, R) in the drawing refers to a stacked layer body of the first optical element 201B, the second optical element 201G, and the third optical element 201R shown in FIG. 15, and 202 (B, G, R) in the drawing refers to a stacked layer body of the first optical element 202B, the second optical element 202G, and the third optical element 202R shown in FIG. 15.

In FIG. 16, the optical action of transmitting the optical element 201 (B, G, R) is the same as that described with reference to FIG. 11, and descriptions are omitted. In addition, the liquid crystal element 10 is assumed to be optimized to, for example, the light of the green wavelength (second wavelength) λg.

In this case, the second circularly polarized light CP2 of the second wavelength, of the second circularly polarized light CP2 transmitted through the optical element 201 (B, G, R), is converted into the first circularly polarized light CP1 in the first element L1 and is subjected to the lens action, in the liquid crystal element 10. The first circularly polarized light CP1 transmitted through the liquid crystal element 10 is transmitted through the optical element 202 (B, G, R) and then condensed to the user's pupil E by the lens action of the liquid crystal element 10.

Each of the second circularly polarized light CP2 of the first wavelength and the second circularly polarized light CP2 of the third wavelength, of the second circularly polarized light CP2 transmitted through the optical element 201 (B, G, R), is converted into the first circularly polarized light CP1 and condensed by the lens action, in the liquid crystal element 10, and part of each of the second circularly polarized light CP2 is transmitted through the liquid crystal element 10 without being converted into the first circularly polarized light. Such second circularly polarized light CP2 is not subjected to the lens action in the liquid crystal element 10, but becomes unnecessary light.

The second circularly polarized light CP2 that is unnecessary light is reflected in the optical element 202 (B, G, R), and converted into the first circularly polarized light CP1 when transmitted through the liquid crystal element 10. The first circularly polarized light CP1 is reflected on the optical element 201 (B, G, R) and is converted into the second circularly polarized light CP2 when transmitted through the liquid crystal element 10 again, and small first circularly polarized light CP1 is transmitted through the liquid crystal element 10 without being converted into the second circularly polarized light.

The second circularly polarized light CP2 transmitted through the liquid crystal element 10 is reflected again on the optical element 202 (B, G, R). In addition, the small first circularly polarized light CP1 transmitted through the liquid crystal element 10 is transmitted through the optical element 202 (B, G, R), and the rate of the unnecessary light to the light reaching the user's pupil E is small and the influence to the display quality is small.

According to the third configuration example, the same advantages as those of the first configuration example can be obtained. In addition, unnecessary light which is not subjected to the lens action in the liquid crystal element 10 is repeatedly reflected between the optical element 201 (B, G, R) and the optical element 202 (B, G, R) and attenuated. Unnecessary light is a reason for multiple image (so called ghost) and, according to the above-described third configuration example, the rate of unnecessary light reaching the user's pupil E can be reduced and degradation in display quality can be suppressed.

### Fourth Configuration Example

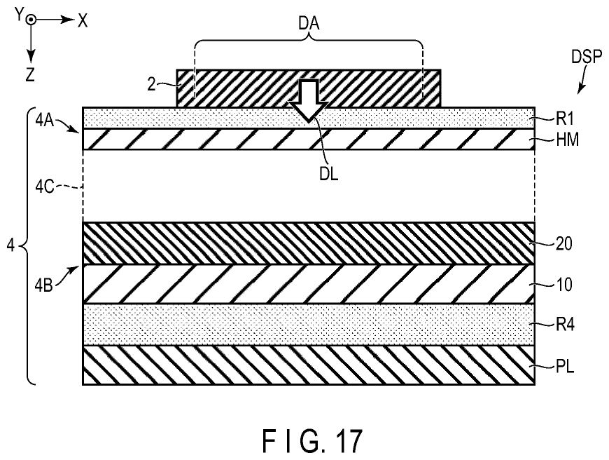

FIG. 17 is a cross-sectional view showing a fourth configuration example of the display device DSP. The fourth configuration example shown in FIG. 17 is different from the second configuration example shown in FIG. 9 in comprising a wide-band type fourth retardation film R4 and a polarizer PL.

The fourth retardation film R4 is a wide-band type retardation film that also assigns an approximately quarter-wave phase difference to the light of each of the red wavelength, the green wavelength and the blue wavelength. Such a wide-band type retardation film can be implemented by, for example, combining the quarter-wave plates and the half-wave plates. The polarizer PL transmits the first linearly polarized light and absorbs the second linearly polarized light. The fourth retardation film R4 and the polarizer PL unction as the wide-band type circularly polarized lights.

The optical element 20, the liquid crystal element 10, the fourth retardation film R4, and the polarizer PL are stacked in this order along the third direction Z. The liquid crystal element 10 is in contact with the optical element 20, the fourth retardation film R4 is in contact with the liquid crystal element 10, and the polarizer PL is in contact with the fourth retardation film R4. The optical element 20 is separated from the semi-transparent layer HM, and is opposed to the semi-transparent layer HM through the air layer 4C in the third direction Z. In addition, the first element 20 is arranged between the semi-transparent layer HM and the liquid crystal element 10, the liquid crystal element 10 is arranged between the optical element 20 and the fourth retardation film R4, and the fourth retardation film R4 is arranged between the liquid crystal element 10 and the polarizer PL.

When the display device DSP shown in FIG. 17 is applied to the head-mounted display 1, the optical element 20 is optimized to correspond to the blue wavelength (first wavelength) λb, the green wavelength (second wavelength) λg, and the red wavelength (third wavelength) λr, similarly to the optical element described in the third configuration example.

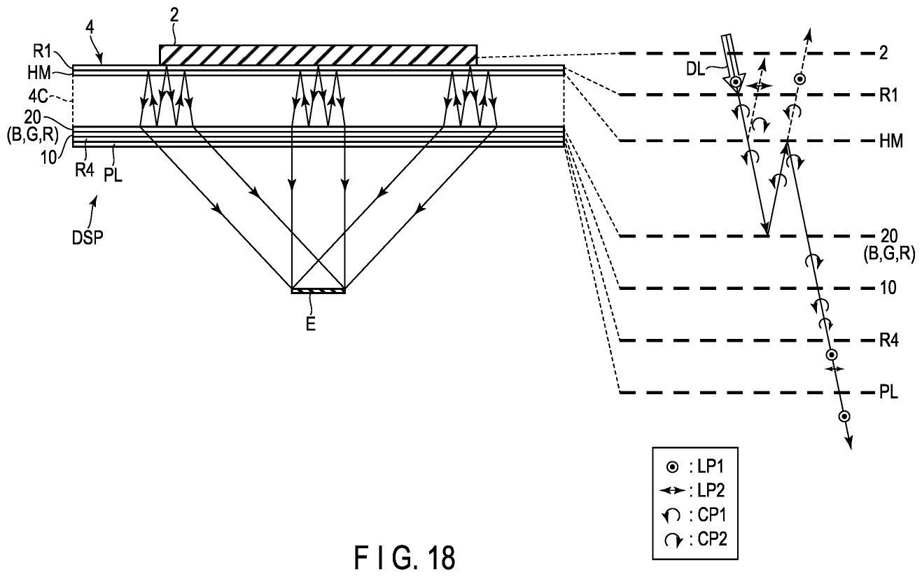

FIG. 18 is a view illustrating an optical action of the display device DSP. In the drawing, 20 (B, G, R) refers to a stacked layer body of the first optical element 20B, the second optical element 20G, and the third optical element 20R.

The first optical element 20B is configured to reflect the first circularly polarized light of the blue wavelength (first wavelength) λb and transmit the second circularly polarized light. The second optical element 20G is configured to reflect the first circularly polarized light of the green wavelength (second wavelength) λg and transmit the second circularly polarized light. The third optical element 20R is configured to reflect the first circularly polarized light of the red wavelength (third wavelength) λr and transmit the second circularly polarized light.

In FIG. 18, the optical action of transmitting the optical element 20 (B, G, R) is the same as that described with reference to FIG. 11, and descriptions are omitted. In addition, the liquid crystal element 10 is assumed to be optimized to, for example, the light of the green wavelength (second wavelength) λg. In this case, the second circularly polarized light CP2 of the second wavelength, of the second circularly polarized light CP2 transmitted through the optical element 20 (B, G, R), is converted into the first circularly polarized light CP1 in the first element L1 and is subjected to the lens action, in the liquid crystal element 10. The first circularly polarized light CP1 transmitted through the liquid crystal element 10 is converted into the first linearly polarized light LP1 when transmitted through the fourth retardation film R4. This first linearly polarized light LP1 is transmitted through the polarizer PL, and is condensed on the user's pupil E by the lens action of the liquid crystal element 10.

Each of the second circularly polarized light CP2 of the first wavelength and the second circularly polarized light CP2 of the third wavelength, of the second circularly polarized light CP2 transmitted through the optical element 20 (B, G, R), is converted into the first circularly polarized light CP1 and condensed by the lens action, in the liquid crystal element 10, and part of each of the second circularly polarized light CP2 is transmitted through the liquid crystal element 10 without being converted into the first circularly polarized light. Such second circularly polarized light CP2 is not subjected to the lens action in the liquid crystal element 10, but becomes unnecessary light.

The second circularly polarized light CP2 that is the unnecessary light is converted into the second linearly polarized light LP2 and absorbed into the polarizer PL, in the wide-broad type fourth retardation film R4.

According to the fourth configuration example, the same advantages as those of the first configuration example can be obtained. In addition, the unnecessary light that is not subjected to the lens action in the liquid crystal element 10 is absorbed into the wide-band type circularly polarized light configured by the fourth retardation film R4 and the polarizer PL, and hardly reaches the user's pupil E. Degradation in display quality can be therefore suppressed.

As described above, according to the embodiments, the display device capable of thinning and reducing the weight can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display panel emitting display light of linearly polarized light;
a semi-transparent layer;
a first retardation film arranged between the display panel and the semi-transparent layer;
a reflective polarizer transmitting first linearly polarized light and reflecting second linearly polarized light orthogonal to the first linearly polarized light;
a second retardation film arranged between the semi-transparent layer and the reflective polarizer;
an element separated from the reflective polarizer; and
a third retardation film arranged between the reflective polarizer and the element, wherein
the first retardation film, the second retardation film, and the third retardation film are quarter-wave plates, and
the element having a lens action of condensing first circularly polarized light.

2. A display device comprising:
a display panel emitting display light of linearly polarized light;
a semi-transparent layer;
a first retardation film arranged between the display panel and the semi-transparent layer;
an element separated from the semi-transparent layer; and
a first optical element being arranged between the semi-transparent layer and the element, separated from the semi-transparent layer, containing first cholesteric liquid crystal, reflecting first circularly polarized light toward the semi-transparent layer, and transmitting second circularly polarized light in a reverse direction to the first circularly polarized light, wherein
the first retardation film is a quarter-wave plate, and
the element has a lens action of condensing the second circularly polarized light.

3. The display device of claim 1, wherein
the element includes a liquid crystal layer cured in a state in which alignment directions of a plurality of liquid crystal molecules containing first liquid crystal molecules and second liquid crystal molecules are fixed,
the liquid crystal layer includes, in planar view, a first annular region in which the plurality of first liquid crystal molecules are aligned in a same direction and a second annular region in which the plurality of second liquid crystal molecules are aligned in a same direction outside the first annular region, and
the alignment directions of the first liquid crystal molecules are different from the alignment directions of the second liquid crystal molecules.

4. The display device of claim 3, further comprising:
an illumination device arranged on a back surface of the display panel,
wherein
the illumination device comprises a first light emitting element that emits light of a first wavelength, a second light emitting element that emits light of a second wavelength longer than the first wavelength, and a third light emitting element that emits light of a third wavelength longer than the second wavelength.

5. The display device of claim 4, wherein
the first light emitting element, the second light emitting element, and the third light emitting element are laser light sources.

6. The display device of claim 2, wherein
the first optical element includes a liquid crystal layer cured in a state in which alignment directions of a plurality of liquid crystal molecules are fixed, and
the liquid crystal layer contains the first cholesteric liquid crystal and has a reflective plane that reflects circularly polarized light of a first wavelength.

7. The display device of claim 6, further comprising:
a second optical element containing second cholesteric liquid crystal and reflecting circularly polarized light of a second wavelength longer than the first wavelength; and
a third optical element containing third cholesteric liquid crystal and reflecting circularly polarized light of a third wavelength longer than the second wavelength,
wherein
the first optical element, the second optical element, and the third optical element are stacked,
a second helical pitch of the second cholesteric liquid crystal is larger than a first helical pitch of the first cholesteric liquid crystal, and
a third helical pitch of the third cholesteric liquid crystal is larger than a second helical pitch of the second cholesteric liquid crystal.

8. The display device of claim 7, further comprising:
an illumination device arranged on a back surface of the display panel,
wherein
the illumination device comprises a first light emitting element that emits light of the first wavelength, a second light emitting element that emits light of the second wavelength, and a third light emitting element that emits light of the third wavelength.

9. The display device of claim 8, wherein
the first light emitting element, the second light emitting element, and the third light emitting element are laser light sources.

10. A display device comprising:
a display panel emitting display light of linearly polarized light;
a semi-transparent layer;
a first retardation film arranged between the display panel and the semi-transparent layer;
a first element being separated from the semi-transparent layer, containing cholesteric liquid crystal, reflecting first circularly polarized light toward the semi-transparent layer, and transmitting second circularly polarized light in a reverse direction to the first circularly polarized light;
a second element containing cholesteric liquid crystal, reflecting the second circularly polarized light, and transmitting the first circularly polarized light; and
an element separated from the semi-transparent layer and arranged between the first element and the second element, wherein
the first retardation film is a quarter-wave plate, and
the element has a lens action of condensing the second circularly polarized light.

11. The display device of claim 10, wherein
each of the first element and the second element includes a liquid crystal layer cured in a state in which alignment directions of a plurality of liquid crystal molecules are fixed.

12. The display device of claim 11, wherein
each of the first element and the second element comprises:
a first optical element containing first cholesteric liquid crystal and reflecting circularly polarized light of a first wavelength;
a second optical element containing second cholesteric liquid crystal and reflecting circularly polarized light of a second wavelength longer than the first wavelength; and
a third optical element containing third cholesteric liquid crystal and reflecting circularly polarized light of a third wavelength longer than the second wavelength,
the first optical element, the second optical element, and the third optical element are stacked,
a second helical pitch of the second cholesteric liquid crystal is larger than a first helical pitch of the first cholesteric liquid crystal, and
a third helical pitch of the third cholesteric liquid crystal is larger than a second helical pitch of the second cholesteric liquid crystal.

13. A display device comprising:
a display panel emitting display light of linearly polarized light;
a semi-transparent layer;
a first retardation film arranged between the display panel and the semi-transparent layer;
an element separated from the semi-transparent layer;
a first optical element being arranged between the semi-transparent layer and the element, containing first cholesteric liquid crystal, reflecting first circularly polarized light toward the semi-transparent layer, and transmitting second circularly polarized light in a reverse direction to the first circularly polarized light;
a polarizer; and
a fourth retardation film arranged between the element and the polarizer, wherein
the first retardation film and the fourth retardation film are quarter-wave plates, and
the element has a lens action of condensing the second circularly polarized light.

14. The display device of claim 13, further comprising:
an illumination device arranged on a back surface of the display panel,
wherein
the illumination device comprises a first light emitting element that emits light of a first wavelength, a second light emitting element that emits light of a second wavelength longer than the first wavelength, and a third light emitting element that emits light of a third wavelength longer than the second wavelength, and
the fourth retardation film is a wide-band type retardation film that assigns a quarter-wave phase difference to the light of each of the first wavelength, the second wavelength, and the third wavelength.

15. The display device of claim 2, wherein
the element includes a liquid crystal layer cured in a state in which alignment directions of a plurality of liquid crystal molecules containing first liquid crystal molecules and second liquid crystal molecules are fixed,
the liquid crystal layer includes, in planar view, a first annular region in which the plurality of first liquid crystal molecules are aligned in a same direction and a second annular region in which the plurality of second liquid crystal molecules are aligned in a same direction outside the first annular region, and
the alignment directions of the first liquid crystal molecules are different from the alignment directions of the second liquid crystal molecules.

16. The display device of claim 15, further comprising:
an illumination device arranged on a back surface of the display panel,
wherein
the illumination device comprises a first light emitting element that emits light of a first wavelength, a second light emitting element that emits light of a second wavelength longer than the first wavelength, and a third light emitting element that emits light of a third wavelength longer than the second wavelength.

17. The display device of claim 16, wherein
the first light emitting element, the second light emitting element, and the third light emitting element are laser light sources.
